(19) United States
(12) Patent Application Publication
(10) Pub. No.: US 2026/0162026 A1
(43) Pub. Date: Jun. 11, 2026

(54) Finding Meeting Locations for Mapping Applications

(71) Applicant: Matthew Chou, San Jose, CA (US)

(72) Inventor: Matthew Chou, San Jose, CA (US)

(21) Appl. No.: 18/971,351

(22) Filed: Dec. 6, 2024

(51) Int. Cl. G06Q 10/047

(52) U.S. Cl. CPC G06Q 10/047

(57) ABSTRACT

Techniques for finding an optimal meeting location using distributed computing may include for finding a centroid node within a network given a set of source nodes. Methods include creating a priority queue for each source node, iteratively updating distances and/or sums of distances for unvisited nodes from the priority queue using a shortest path algorithm, alternating between the priority queues for each of the plurality of source nodes, and updating a minsum value each time a smaller sum of distances is found. The method also includes terminating the shortest path algorithm once a stopping condition is met (e.g., a sum of distances for an extracted node is found to be larger than a minsum value). When all source nodes have been terminated, a centroid node may be determined and sent to the source nodes. The centroid node may represent a meeting location.

### BACKGROUND OF INVENTION

There exist many real-world problems where finding the center of a graph is deemed useful and also where the center may be defined in many different ways. In the field of computer networks, finding the center of nodes in a network to determine where to place servers is one example. Another example is a facility location problem where one wants to build a set of facilities that lies within the center of a set of nodes, each node representing a residential home, a business, etc. Still another example is finding a location for several people (i.e., a group) to meet. This location should be “fair” in the sense that it minimizes a maximum or a total distance or time for a group of people.

The case of finding the center node in a network or a facility location are widely known and studied, for example, the known K-Center problem, K-Median problem, and Jordan Center problem, all providing various solutions. The K-Center problem utilizes a selecting algorithm that, given a set of data, selects the best points to create facilities either at random, through a 2-approximation method or other means. Like the K-Center problem, the K-Median problem utilizes a selecting algorithm that works either randomly or updates itself upon every iteration. Both of these solutions do not have any practical application to problems where you are finding a center or centroid for a group or set of nodes less than the total set of nodes. The Jordan center similarly requires consideration of all nodes.

Bidirectional Dijkstra's Algorithm can provide a solution to find the shortest path between two nodes. However, it does not offer a solution for finding a center or centroid amongst a plurality of source nodes within a graph (i.e., network) comprising a large number of nodes.

Thus, there is a need for an improved method for finding an optimal meeting location for a group comprising less than all nodes in a graph.

### BRIEF SUMMARY

The present disclosure provides techniques for finding an optimal meeting location using distributed edge computation. A method for finding the center of a plurality of source nodes a network comprising a larger set of nodes may include: creating a priority queue for each source node of the plurality of source nodes, the priority queue comprising other nodes in the larger set of nodes in the network; initializing a distance for each of the plurality of source nodes to 0, a distance for the other nodes in the larger set of nodes to ∞, and a minimax to co; selecting and extracting an unvisited node for a source node, the unvisited node having a smallest value for shortest path distance to the source node; updating a distance from a current extracted node to each of its neighboring nodes using Dijkstra's algorithm; comparing a maximum distance for the source node to the minimax; if the current extracted node comprises an intersection node, the intersection node having an updated distance to each of the plurality of source nodes, and the maximum distance is less than the minimax, updating the minimax to the maximum distance; determining whether a stopping condition is met; if the stopping condition is not met, iteratively updating distances using Dijkstra's algorithm for remaining unvisited nodes from the priority queue, alternating between the priority queues for each of the plurality of source nodes; and after the stopping condition is met for the source node, terminating the Dijkstra's algorithm for the source node; determining whether the Dijkstra's algorithm has been terminated for all of the plurality of source nodes; if the Dijkstra's algorithm has been terminated for all of the plurality of source nodes, outputting a center node comprising the intersection node having the maximum distance equal to the minimax, wherein the minimax comprises the smallest maximum distance.

In some examples, the method also includes storing a shortest path for the extracted node. In some examples, the method also includes marking the current extracted node as visited after updating its distances to each of its neighboring nodes. In some examples, the stopping condition is met when the maximum distance for a current intersection node is larger than the minimax. In some examples, the method also includes sending, by a server, a termination instruction to the source node for which the stopping condition is met. In some examples, the termination instructions comprises a bit. In some examples, the method also includes returning an updated minimax to the plurality of source nodes. In some examples, the updating the distance for a current extracted node using the Dijkstra's algorithm is performed by a source node comprising an edge device. In some examples, the updating the minimax is performed by a server in a network comprising the server and the plurality of source nodes. In some examples, outputting the center node comprises sending the center node to all remaining connected source nodes. In some examples, the method also includes exploring nodes near the center node using Dijkstra's algorithm to satisfy a criterion. In some examples, the criterion is related to a meeting place.

A method for finding the centroid of a plurality of source nodes a network comprising a larger set of nodes may include: creating a priority queue for each source node of the plurality of source nodes, the priority queue comprising other nodes in the larger set of nodes in the network; initializing a distance for each of the plurality of source nodes to 0, a distance for the other nodes in the larger set of nodes to ∞, and a minsum to ∞; selecting and extracting an unvisited node having a smallest value for shortest path distance to a source node; updating a sum of distances for a current extracted node using a shortest path algorithm, the sum of distances comprising a sum total of distances from the current extracted node to all of the plurality of source nodes; if the current extracted node comprises an intersection node, the intersection node having an updated distance to each of the plurality of source nodes, comparing a sum of distances for the intersection node with the minsum; if the sum of distances is less than the minsum, updating the minsum to the sum of distances; determining whether a stopping condition is met; if the stopping condition is not met, iteratively updating sums of distances using the shortest path algorithm for remaining unvisited nodes from the priority queue, alternating between the priority queues for each of the plurality of source nodes; after the stopping condition is met for the source node, terminating the shortest path algorithm for the source node; determining whether the shortest path algorithm has been terminated for all of the plurality of source nodes; if the shortest path algorithm has been terminated for all of the plurality of source nodes, outputting a centroid node comprising the intersection node having a sum of distances equal to the minsum wherein the minsum comprises the smallest sum of distances.

In some examples, the shortest path algorithm comprises one of a Dijkstra's algorithm or an A* algorithm. In some examples, the method also includes applying a heuristic function when using the A* algorithm, the heuristic function comprising a maximum distance from the current extracted node to all sources. In some examples, the method also includes storing a smallest sum of distances for the extracted node. In some examples, the method also includes marking the current extracted node as visited after updating its sum of distances. In some examples, the stopping condition is met when the sum of distances for a current intersection node is larger than the minsum. In some examples, the method also includes sending, by a server, a termination instruction to the source node for which the stopping condition is met. In some examples, the termination instructions comprises a bit. In some examples, the method also includes returning an updated minsum to the plurality of source nodes. In some examples, the updating the sum of distances for a current extracted node is performed by a source node comprising an edge device. In some examples, the updating the minsum is performed by a server in a network comprising the server and the plurality of source nodes. In some examples, outputting the centroid node comprises sending the centroid node to all remaining connected source nodes. In some examples, the method also includes exploring nodes near the centroid node using Dijkstra's algorithm to satisfy a criterion. In some examples, the criterion is related to a meeting place.

A system for finding the center of a plurality of source nodes a network comprising a larger set of nodes may include: a memory comprising non-transitory computer-readable storage medium configured to store algorithms, minimax values, and data; and one or more processors in a distributed computing system configured to execute instructions stored on the non-transitory computer-readable storage medium to: create a priority queue for each source node of the plurality of source nodes, the priority queue comprising other nodes in the larger set of nodes in the network; initialize a distance for each of the plurality of source nodes to 0, a distance for the other nodes in the larger set of nodes to ∞, and a minimax to ∞; select and extract an unvisited node for a source node, the unvisited node having a smallest value for shortest path distance to the source node; update a distance from a current extracted node to each of its neighboring nodes using Dijkstra's algorithm; compare a maximum distance for the source node to the minimax; if the current extracted node comprises an intersection node, the intersection node having an updated distance to each of the plurality of source nodes, and the maximum distance is less than the minimax, update the minimax to the maximum distance; determine whether a stopping condition is met; if the stopping condition is not met, iteratively update distances using Dijkstra's algorithm for remaining unvisited nodes from the priority queue, alternating between the priority queues for each of the plurality of source nodes; and after the stopping condition is met for the source node, terminate the Dijkstra's algorithm for the source node; determine whether the Dijkstra's algorithm has been terminated for all of the plurality of source nodes; if the Dijkstra's algorithm has been terminated for all of the plurality of source nodes, output a center node comprising the intersection node having the maximum distance equal to the minimax, wherein the minimax comprises the smallest maximum distance.

A system for finding the centroid of a plurality of source nodes a network comprising a larger set of nodes may include: a memory comprising non-transitory computer-readable storage medium configured to store algorithms, minsum values, and data; and one or more processors in a distributed computing system configured to execute instructions stored on the non-transitory computer-readable storage medium to: create a priority queue for each source node of the plurality of source nodes, the priority queue comprising other nodes in the larger set of nodes in the network; initialize a distance for each of the plurality of source nodes to 0, a distance for the other nodes in the larger set of nodes to ∞, and a minsum to ∞; select and extract an unvisited node having a smallest value for shortest path distance to a source node; update a sum of distances for a current extracted node using a shortest path algorithm, the sum of distances comprising a sum total of distances from the current extracted node to all of the plurality of source nodes; if the current extracted node comprises an intersection node, the intersection node having an updated distance to each of the plurality of source nodes, compare a sum of distances for the intersection node with the minsum; if the sum of distances is less than the minsum, update the minsum to the sum of distances; determine whether a stopping condition is met; if the stopping condition is not met, iteratively update sums of distances using the shortest path algorithm for remaining unvisited nodes from the priority queue, alternating between the priority queues for each of the plurality of source nodes; after the stopping condition is met for the source node, terminate the shortest path algorithm for the source node; determine whether the shortest path algorithm has been terminated for all of the plurality of source nodes; if the shortest path algorithm has been terminated for all of the plurality of source nodes, output a centroid node comprising the intersection node having a sum of distances equal to the minsum wherein the minsum comprises the smallest sum of distances.

### BRIEF DESCRIPTION OF THE DRAWINGS

Various non-limiting and non-exhaustive aspects and features of the present disclosure are described herein below with references to the drawings wherein:

FIG. 1 is a graph indicating a state of a plurality of nodes comprising source nodes and a center found by a method for finding a meeting location, in accordance with one or more embodiments.

FIG. 2 is a graph indicating a state of a plurality of nodes comprising source nodes and a centroid found by a method for finding a meeting location, in accordance with one or more embodiments.

FIG. 3 is a diagram illustrating a data flow between client side sources and a server in a distributed computing environment, in accordance with one or more embodiments.

FIGS. 4A-4B are flow diagrams illustrating a method for finding a meeting location, in accordance with one or more embodiments.

FIG. 5A is a simplified block diagram of an exemplary computing system configured to perform steps of the protocol shown in FIG. 3 and the methods illustrated in FIGS. 4A-4B, in accordance with one or more embodiments.

FIG. 5B is a simplified block diagram of an exemplary distributed computing system implemented by a plurality of the computing devices in FIG. 5A, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to finding an optimal meeting location using distributed edge computation. In a case where a “fair” meeting place is defined to be either 1) a node on a graph that minimizes the maximum time/distance to each person or 2) a node on a graph that minimizes the sum of times/distances to each person, a method for finding the optimal meeting location may comprise a low complexity algorithm configured to compute a center of S sources among N nodes. In graph theory, these nodes may be denoted as the center or centroid of a graph, respectively. A novel solution for finding the center and centroid of a graph may comprise an algorithm using a multiple source alternating Dijkstra's Algorithm and a stopping condition that significantly saves time complexity without compromising the accuracy of the solution.

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention comprises a method for finding an optimal meeting location using distributed edge computation, wherein the optimal meeting location comprises a center and/or centroid of S sources among N nodes, S being significantly fewer than N−S<<N. In some examples, the method uses a multiple source Dijkstra's Algorithm or A* Algorithm. In some examples, the method comprises a stopping condition that is optimal for finding the center and near optimal for finding the centroid, while providing significant complexity savings. In some examples, the method be performed in a distributed manner, between a plurality of edge devices (e.g., as many edge devices as there are sources).

### Methods

Finding the center of S sources involves minimizing the maximum time/distance to a common location. The optimization problem for finding a center may be expressed as:

$$\hat{υ} = arg {min}_{{v}_{i} ∈ V} {max}_{{s}_{j} ∈ S} d ( {v}_{i} , {s}_{j} ) \qquad ( 1 )$$

where V is the set of all vertices within the graph and S is the set of all source nodes.

In order to determine the node û with the minimum value of

$$f ( {v}_{j} ) = {max}_{{s}_{j} ∈ S} d ( {v}_{i} , {s}_{j} ) ,$$

a Dijkstra's Algorithm may be run in alternating steps from each source node, storing the shortest path for every node. By storing the shortest path from every node to every source node, one is able to determine the ƒ(vⱼ) value for all nodes by keeping track of the maximum shortest path to all source nodes. The method also comprises maintaining a separate priority queue for each source node and alternating between the queues after a node from one queue has been extracted and evaluated. A priority queue for a source node begins at the source node and adds all neighboring nodes into the queue. In other words, the method comprises switching between source nodes while exploring and evaluating a source node's priority queue for a shortest path. An exemplary algorithm for determining an optimal location û is provided in Algorithm 1.

Algorithm 1: Multiple Source Dijkstra's Algorithm for Finding the Center

1) Initialization: Create a priority queue for each source node and initialize the distance
of source nodes to 0 and all the other nodes to ∞
2) Selection: Pick the unvisited node with the smallest d(sᵢ, v) (initially the source
node) and extract node
3) Relaxation: For the extracted node, check all neighboring nodes and compare/update
its distances. If extracted node has been visited by all sources, keep track of its
maximum distance to all source nodes
4) Alternation: The extracted node is marked as visited and will not be visited again.
Repeat steps 2-3 alternating between each of the sources, for all nodes
5) Stopping: Find the node with the minimum eccentricity to all nodes. Alternatively, the
minimum eccentricity could be kept track of whenever a node is extracted and has been
visited by all sources.

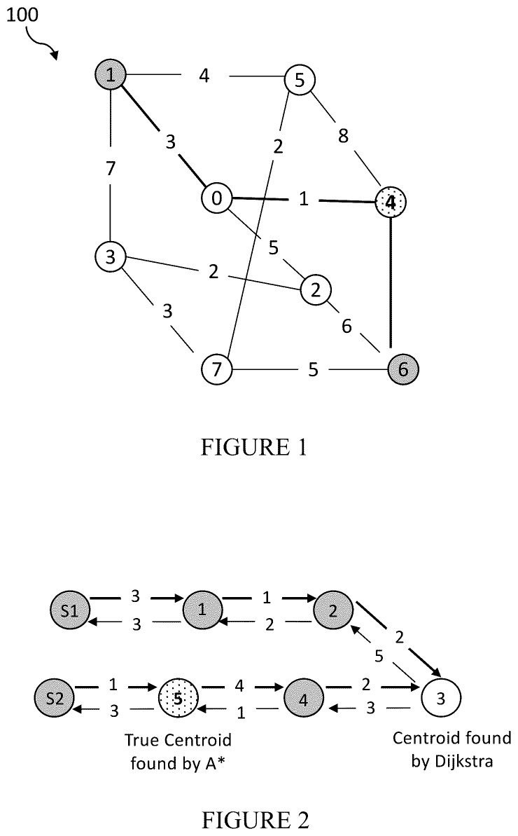

FIG. 1 is a graph indicating the state of a plurality of nodes comprising source nodes and a center, in accordance with one or more embodiments. In FIG. 1, the method provided by Algorithm 1 has found Node 4 to be the center given Nodes 1 and 6 as source nodes. In Algorithm 1, there is no stopping condition, and all nodes are explored. The node with the minimum eccentricity to all nodes is determined to be the optimal (i.e., meeting/center) location.

In other examples described herein, the method may comprise a stopping condition that performs an additional check upon finding the first intersection node. After finding a first intersection node vᵤ (i.e., an extracted node that has been visited by all sources), a variable called minimax may be assigned the value of ƒ(vᵤ), or the maximum distance value for intersection node vᵤ. Then, whenever another intersection node is encountered, its maximum distance value is checked against the current (i.e., updated) minimax. If the maximum distance value is less than minimax, then minimax is updated to equal this maximum distance value (i.e., for the current intersection node). If the maximum distance value is larger than minimax, then the iterative steps of the method (i.e., the exploration steps) may be terminated and the intersection node having a maximum distance value equal to the minimax may be output as the center node.

Therefore, a method for finding an optimal meeting location using distributed edge computing may comprise initiating S Dijkstra's Algorithms from S difference source nodes. Once a node has been visited by all S Dijkstra's Algorithms, then let these nodes be called intersection nodes and let dₘₐₓ for an intersection node represent the maximum distance to all source nodes from the intersection node. Then, for any of the S Dijkstra's Algorithms, if a node is extracted from its priority queue with a distance that exceeds dₘₐₓ, then all remaining nodes that are to be explored for that Dijkstra's Algorithm cannot result in a smaller maximum distance than dₘₐₓ. Since Dijkstra's Algorithm extracts nodes in a non-decreasing manner, each successive extracted node's distance cannot be smaller than a previously extracted node's distance. If an extracted node has a distance d larger than dₘₐₓ, then any extracted node after that will have a distance larger than d and therefore larger than dₘₐₓ, and any maximum distance that is calculated based on remaining nodes cannot result in a smaller maximum distance than dₘₐₓ. Therefore, if an extracted node has a distance larger than minimax, all remaining nodes will result in a maximum distance larger than minimax, and none of these remaining nodes can be a center. Thus, an improved stopping condition for each Dijkstra's Algorithm may be to check if an extracted node has a distance larger than minimax, and if it does, then terminate the Dijkstra's Algorithm. Algorithm 2 below expresses the improved algorithm with the modified stopping condition.

Algorithm 2: Multiple Source Dijkstra's Algorithm for
Finding the Center with an Improved Stopping Condition

1) Initialization: Create a priority queue for each source node and initialize the distance of
source nodes to 0 and all the other nodes to o. Set minimax to ∞.
2) Selection: Pick the unvisited node with the smallest d(sᵢ, v) (initially the source node)
and extract node
3) Relaxation: For the extracted node, check all neighboring nodes and compare/update
its distances. If extracted node has been visited by all sources, compare its maximum
distance to minimax. If it is less than minimax, then set minimax to this maximum
distance.
4) Alternation: The extracted node is marked as visited and will not be visited again. If
the extracted node has a distance that is larger than minimax then go to step 5.
Otherwise, repeat steps 2-3 alternating between each of the sources that have not been
terminated, for all nodes.
5) Stopping: If all sources have been terminated then the center is the node with value
minimax and minimax is the smallest distance. Otherwise repeat steps 2-3 alternating
between each of the sources that have not been terminated, for all nodes.

For the example in FIG. 1, Algorithm 2 may find the optimal node (e.g., Node 4) by exploring only a subset of the nodes (e.g., 50% or 8 nodes or less).

In some examples, one may wish to find a solution that minimizes total time/distance to a common location instead of minimizing the maximum time/distance to a common location. Finding the centroid of S sources is equivalent to minimizing a total time/distance to a common location. The optimization problem for finding a center may be expressed as:

$$\hat{υ} = arg {min}_{{υ}_{i} ∈ V} {\sum }_{j} d ( {υ}_{i} , {s}_{j} ) \qquad ( 2 )$$

where V is the set of all vertices within the graph and sⱼ∈S represents the jth source node with S representing the set of all sources.

Similar to finding the center of the S sources, we can apply an algorithm based on a multiple source Dijkstra's Algorithm. However, instead of optimizing for the function ƒ(vⱼ), the algorithm optimizes for g(vᵢ) where g(vᵢ)=Σⱼd(vᵢ, sⱼ). The node with the minimum value of g(vᵢ) is the centroid. In addition to the steps in Algorithm 1, and alternatively Algorithm 2, the sum of distances to each source may also be tracked, the sum of distances comprising a sum total of distances from a current extracted node to all of the source nodes. In Algorithm 3 below, the stopping condition is modified again to check for any intersection node where the sum of distances is larger than the previously stored minimum sum of distances (i.e., minsum). If it is, then we can update this minsum. Otherwise, we can terminate the Dijkstra's Algorithm that resulted in a larger sum of distances.

Algorithm 3: Multiple Source Dijkstra's Algorithm for Finding the Centroid

1) Initialization: Create a priority queue for each source node and initialize the distance of
source nodes to 0 and all the other nodes to co. Set minsum to ∞.
2) Selection: Pick the unvisited node with the smallest d(sᵢ, v) (initially the source node)
and extract node
3) Relaxation: For the extracted node, check all neighboring nodes and compare/update
its distances. If extracted node has been visited by all sources, compare its sum of
distances to minsum. If it is less than minsum, then set minsum to this sum of
distances.
4) Alternation: The extracted node is marked as visited and will not be visited again. If
the extracted node has been visited by all sources and results in a sum that is larger than
minsum then go to step 5. Otherwise, repeat steps 2-3 alternating between each of the
sources that have not been terminated, for all nodes.
5) Stopping: If all sources have been terminated then the centroid is the node with value
minsum and minsum is the smallest sum of distances. Otherwise, repeat steps 2-3
alternating between each of the sources that have not been terminated, for all nodes.

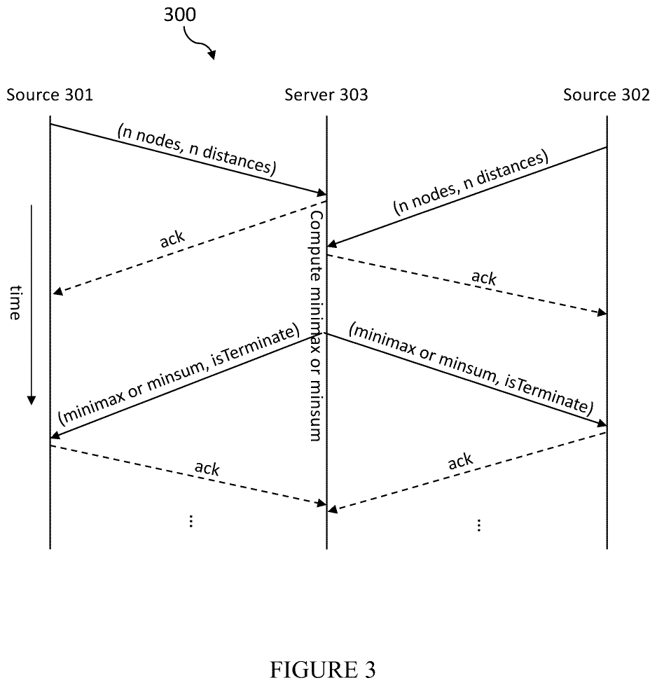

In some examples, Algorithm 3 may end up finding a relative minimum instead of a global minimum, for example, using an A* algorithm. So alternatively, we can utilize the A* algorithm instead of Dijkstra's algorithm in Algorithm 3, applying a heuristic function to A* to reduce the number of explored nodes without reducing accuracy. A heuristic function that may be used guides the A* algorithm based off of distances to each source node. A cost function may be defined as ƒ(n)=g(n)+h(n), with the following heuristic function:

$$h ( n ) = {max}_{{s}_{j} ∈ S} ( d ( {υ}_{i} , {s}_{j} ) ) \qquad ( 3 )$$

where vᵢ is a current vertex (i.e., node) and S is the set of all sources. The heuristic function may comprise the maximum distance from the current vertex to all sources and should be smaller than the actual distance between nodes. Other steps of Algorithm 3 may remain the same, including creating and maintaining a priority queue, and alternating between sources. FIG. 2 is a graph indicating a state of a plurality of nodes comprising source nodes and a centroid found by a method for finding an optimal meeting location (e.g., Algorithm 3), in accordance with one or more embodiments. As shown in FIG. 2, implementing Algorithm 3 with a Dijkstra algorithm may result in finding a less than optimal solution (e.g., with a sum of distances from sources S1 and S2 of 13). However, implementing Algorithm 3 with an A* algorithm and applying the above heuristic will result in finding the true centroid and optimal solution (e.g., with a sum of distances from sources S1 and S2 of 11).

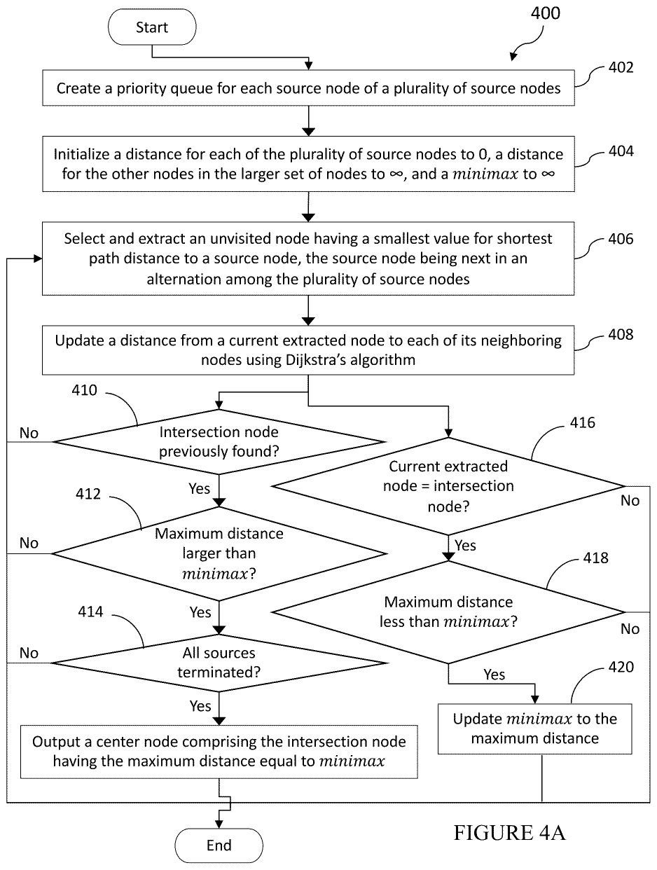

FIG. 3 is a diagram illustrating a flow of data between client-side sources and a server in a distributed computing environment, in accordance with one or more embodiments. Sources 301-302 may comprise edge devices in a computer network that includes server 303. In some examples, server 303 may receive and maintain real-time information about the graph. In some examples, a location of each of sources 301-302 may be sent to a server 303. Then server 303 may compute a center or a centroid, and send it back to each of sources 301-302, respectively. In other examples, computation may be distributed among the network devices such that each of sources 301-302 may run its own Dijkstra's algorithm on nodes from its respective priority queue and send the computed nodes and distances to server 303. Server 303 may then determine whether a source's Dijkstra's algorithm should be terminated. Diagram 300 shows a protocol for distributing the computation between S devices (e.g., sources 301-302). Although diagram 300 shows only sources 301-302, a network may include more sources (e.g., edge devices) in communication with server 303. In some examples, each of the edge devices (e.g., sources 301-302) may run n iterations where n may be any number from 1 to N. Each edge device then sends the n nodes and n distances to server 303. After server 303 receives the information from a source that has not yet been terminated, it will update the minimax and/or the minsum and decide whether the source that provided the information should be terminated. A termination instruction (e.g., message) may be sent back to each source to indicate whether that source should be terminated, for example in the form of a bit (e.g., isTerminate). The protocol may end when all sources are terminated, at which point server 303 may send the center and/or centroid (i.e., node(s)) to all edge devices that remain connected (e.g., one or both of sources 301-302, and any other remaining connected source nodes). In some examples, each of sources 301-302 may run n iterations at a time where n may be larger than 1 in order to reduce overhead of sending nodes and distances to the server by bundling n of them together.

If one of a plurality of sources disconnects from the server at any time during the performance of any of the methods and protocols described herein, the process or protocol may continue with the remaining sources, and an optimal center and/or centroid still may be found among the remaining sources.

In some examples, if the center or centroid does not meet a desired criterion (e.g., for a desired type of meeting place), any of the algorithms described herein may be run from the center or centroid to explore nearby nodes that meet the desired criterion. For example, a desired criterion may be for the meeting place to be a given type of establishment (e.g., a restaurant, a café, a gym, etc.), but the center or centroid found is not the given type of establishment. A further step in the method may be to run a Dijkstra's algorithm from the center or centroid to find a nearest node to the center or centroid that is the given type of establishment.

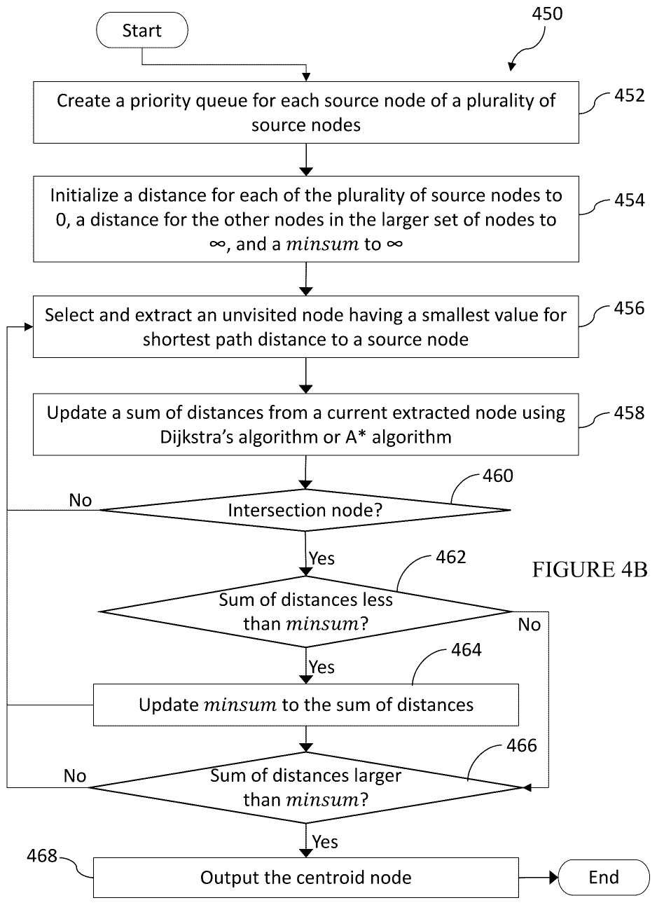

FIGS. 4A-4B are flow diagrams illustrating a method for finding an optimal meeting location using distributed edge computation, in accordance with one or more embodiments. In FIG. 4A, method 400 may begin by creating a priority queue for each source node of a plurality of source nodes at step 402. In some examples, the priority queue may comprise the other nodes in a larger set of nodes in the network. At step 404, a distance for each of the plurality of source nodes may be initialized to 0, a distance for the other nodes in the larger set of nodes initialized to co, and a minimax value also initialized to ∞. An unvisited node (e.g., for a first source or a next source) may be selected and extracted at step 406, the unvisited node having a smallest value for shortest path distance to a source node. For the relaxation part of the algorithm, a distance from a current extracted node to each of its neighboring nodes may be updated using Dijkstra's algorithm at step 408. At step 410, a server may determine whether the current extracted node comprises an intersection node, the intersection node having an updated distance to each of the plurality of source nodes (e.g., having been visited by all of the source nodes). If the current extracted node is an intersection node, and the maximum distance is less than the minimax, the minimax is updated to the maximum distance at step 412. The minimax (i.e., current minimax, updated or same as before) is returned to the source node at step 414 for a next iteration.

For the alternation portion of the algorithm, a determination is made whether the maximum distance is larger than the minimax (i.e., a stopping condition is checked) at step 416. If yes, the Dijkstra's algorithm is terminated for that source node at step 418. If the stopping condition is not met, the method returns to selecting and extracting another (i.e., next) unvisited node from the priority queue of another (i.e., next) source node at step 406. The method iteratively updates distances using Dijkstra's algorithm for remaining unvisited nodes from the priority queue, alternating between the priority queues for each of the plurality of source nodes, and comparing the minimax to the maximum distance for each iteration.

If the Dijkstra's algorithm is terminated for the source node at step 418, then a check of whether all sources have been terminated occurs at step 420. If all sources have not yet been terminated, then the iterative process continues as described above. However, if it is determined that all sources have been terminated, then a center node may be output comprising the intersection node having the maximum distance equal to the minimax value at step 422, the minimax representing the smallest maximum distance.

In FIG. 4B, method 450 may begin similarly as above by creating a priority queue for each source node of a plurality of source nodes at step 452. In some examples, the priority queue may comprise the other nodes in a larger set of nodes in the network. At step 454, a distance for each of the plurality of source nodes may be initialized to 0, a distance for the other nodes in the larger set of nodes initialized to ∞, and a minsum value also initialized to ∞. An unvisited node (e.g., for a first source) may be selected and extracted at step 456, the unvisited node having a smallest value for shortest path distance to a source node. In a relaxation portion of the algorithm, a sum of distances for a current extracted node may be updated using a shortest path algorithm (e.g., Dijkstra's algorithm or A* algorithm) at step 458. At step 460, a server may determine whether the current extracted node comprises an intersection node, the intersection node having an updated distance to each of the plurality of source nodes (e.g., having been visited by all of the source nodes). If the current extracted node does not comprise an intersection node, then the method returns to selecting and extracting another (i.e., next) unvisited node from the priority queue of another (i.e., next) source node at step 456. The method iteratively updates distances using Dijkstra's algorithm or A* algorithm for remaining unvisited nodes from the priority queue, alternating between the priority queues for each of the plurality of source nodes. If the current extracted node comprises an intersection node, and the sum of distances is less than the minsum value, the minsum value may be updated to be the sum of distances (i.e., for this intersection node) at step 462. The minsum value may be returned to the source node at step 464 for a next iteration.

For the alternation portion of the algorithm, after a determination that the current extracted node is an intersection node at step 460, a determination also is made at step 466 whether the sum of distances is larger than the minsum value (i.e., a stopping condition is checked). If the stopping condition is not met (i.e., the sum of distances if not larger than the minsum value), the iterative process continues as described above (i.e., the method returns to selecting and extracting another (i.e., next) unvisited node from the priority queue of another (i.e., next) source node). However, if the stopping condition is met (i.e., the sum of distances is larger than the minsum value), then the shortest path algorithm is terminated for that source node at step 468. If all sources have not yet been terminated at step 470, then the iterative process continues as described above. However, if all sources have been terminated at step 470, a centroid node may be output comprising the intersection node having the sum of distances equal to the minsum value at step 472, the minsum representing the smallest sum of distances. When using the A* algorithm, a heuristic function may be applied as described above, the heuristic function comprising a maximum distance from the current extracted node to all sources.

In some examples, the above methods may also include storing one, or a combination of, a shortest path, a maximum distance, and a sum of distances for the extracted node. In some examples, the above methods may also include marking the current extracted node as visited after updating one, or a combination of, its distance to each of its neighboring nodes, its maximum distance, and its sum of distances. As described above, the above methods also may include sending, by a server, a termination instruction (e.g., a bit, as shown in FIG. 3) to the source node for which the stopping condition is met. In a distributed system, as described herein, some of the computations may be performed by an edge device (e.g., a source node), for example, the steps of the Dijkstra's algorithm or A* algorithm including creating the priority queue and updating distances for nodes in the priority queue. In a distributed system, a server may perform the steps of updating the minimax, determining the center node, determining whether the Dijkstra's algorithm may be terminated for a source node, and sending messages and information to said edge devices (e.g., termination instruction, identity of the center node, etc.). In some examples, if one or more source nodes disconnects from the network, a server may continue to determine the center or centroid node based on any remaining source nodes. As described above, there may be additional criterion (e.g., relating to type or characteristics of a node) for a desired meeting location. Once a center or centroid node has been identified, Dijkstra's algorithm may be used to further explore nodes (e.g., locations) near (e.g., closest to) the center or centroid node that meet the criterion.

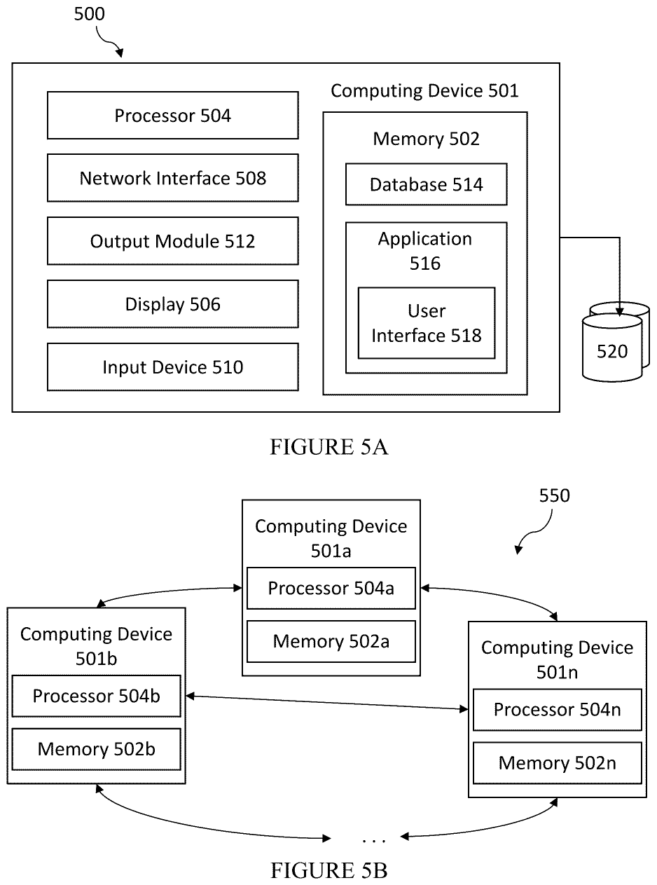

FIG. 5A is a simplified block diagram of an exemplary computing system configured to perform steps of the protocol shown in FIG. 3 and the methods illustrated in FIGS. 4A-4B, in accordance with one or more embodiments. In one embodiment, computing system 500 may include computing device 501 and storage system 520. Storage system 520 may comprise a plurality of repositories and/or other forms of data storage, and it also may be in communication with computing device 501. In another embodiment, storage system 520, which may comprise a plurality of repositories, may be housed in one or more of computing device 501. In some examples, storage system 520 may store distance data, priority queues, values, networks, instructions, programs, and other various types of information as described herein. This information may be retrieved or otherwise accessed by one or more computing devices, such as computing device 501, in order to perform some or all of the features described herein. Storage system 520 may comprise any type of computer storage, such as a hard drive, memory card, ROM, RAM, DVD, CD-ROM, write-capable, and read-only memories. In addition, storage system 520 may include a distributed storage system where data is stored on a plurality of different storage devices, which may be physically located at the same or different geographic locations (e.g., in a distributed computing system such as system 550 in FIG. 5B). Storage system 520 may be networked to computing device 501 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 501, which in some examples may be included in an edge device or a server (e.g., source nodes and servers described herein), also may include a memory 502. Memory 502 may comprise a storage system configured to store a database 514 and an application 516. Application 516 may include instructions which, when executed by a processor 504, cause computing device 501 to perform various steps and/or functions (e.g., implementing methods for finding centers and centroids), as described herein. Application 516 further includes instructions for generating a user interface 518 (e.g., displays on edge or client devices). Database 514 may store various algorithms (e.g., Algorithms 1-3 above, Dijkstra's algorithm, A* algorithm) and/or data, including neural networks, distances data, priority queues, and other data. Memory 352 may include any non-transitory computer-readable storage medium for storing data and/or software that is executable by processor 504, and/or any other medium which may be used to store information that may be accessed by processor 504 to control the operation of computing device 501.

Computing device 501 may further include a display 506, a network interface 508, an input device 510, and/or an output module 512. Display 506 may be any display device by means of which computing device 501 may output and/or display data. Network interface 508 may be configured to connect to a network using any of the wired and wireless short range communication protocols described above, as well as a cellular data network, a satellite network, free space optical network and/or the Internet. Input device 510 may comprise buttons (e.g., buttons 224), a mouse, keyboard, touch screen, voice interface, and/or any or other hand-held controller or device or interface by means of which a user may interact with computing device 501. Output module 512 may be a bus, port, and/or other interfaces by means of which computing device 501 may connect to and/or output data to other devices and/or peripherals.

In one embodiment, computing device 501 may be implemented in a data center, server farm, or other control facility (e.g., configured to run a distributed computing system as described herein), and may communicate with edge devices and other devices described herein. As described herein, system 500, and particularly computing device 501, may be used for computing distances, values, processing data, generating messages, and otherwise implementing steps for finding a center or centroid, as described herein. Various configurations of system 500 are envisioned, and various steps and/or functions of the processes described below may be shared among the various devices of system 500 or may be assigned to specific devices.

FIG. 5B is a simplified block diagram of an exemplary distributed computing system implemented by a plurality of the computing devices in FIG. 5A, in accordance with one or more embodiments. System 550 may comprise two or more computing devices 501a-n. In some examples, each of 501a-n may comprise one or more of processors 504a-n, respectively, and one or more of memory 502a-n, respectively. Processors 504a-n may function similarly to processor 504 in FIG. 5A, as described above. Memory 502a-n may function similarly to memory 502 in FIG. 5A, as described above.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for finding the centroid of a plurality of source nodes a network comprising a larger set of nodes, the method comprising:
creating a priority queue for each source node of the plurality of source nodes, the priority queue comprising other nodes in the larger set of nodes in the network;
initializing a distance for each of the plurality of source nodes to 0, a distance for the other nodes in the larger set of nodes to ∞, and a minsum to ∞;
selecting and extracting an unvisited node having a smallest value for shortest path distance to a source node;
updating a sum of distances for a current extracted node using a shortest path algorithm, the sum of distances comprising a sum total of distances from the current extracted node to all of the plurality of source nodes;
if the current extracted node comprises an intersection node, the intersection node having an updated distance to each of the plurality of source nodes, comparing a sum of distances for the intersection node with the minsum;
if the sum of distances is less than the minsum, updating the minsum to the sum of distances;
determining whether a stopping condition is met;
if the stopping condition is not met, iteratively updating sums of distances using the shortest path algorithm for remaining unvisited nodes from the priority queue, alternating between the priority queues for each of the plurality of source nodes;
after the stopping condition is met for the source node, terminating the shortest path algorithm for the source node;
determining whether the shortest path algorithm has been terminated for all of the plurality of source nodes;
if the shortest path algorithm has been terminated for all of the plurality of source nodes, outputting a centroid node comprising the intersection node having a sum of distances equal to the minsum wherein the minsum comprises the smallest sum of distances.

2. The method of claim 1, wherein the shortest path algorithm comprises one of a Dijkstra's algorithm or an A* algorithm.

3. The method of claim 12, further comprising applying a heuristic function when using the A* algorithm, the heuristic function comprising a maximum distance from the current extracted node to all sources.

4. The method of claim 1, further comprising storing a smallest sum of distances for the extracted node.

5. The method in claim 1, further comprising marking the current extracted node as visited after updating its sum of distances.

6. The method of claim 1, wherein the stopping condition is met when the sum of distances for a current intersection node is larger than the minsum.

7. The method of claim 1, further comprising sending, by a server, a termination instruction to the source node for which the stopping condition is met.

8. The method of claim 7, wherein the termination instructions comprises a bit.

9. The method of claim 1, further comprising returning an updated minsum to the plurality of source nodes.

10. The method in claim 1, wherein the updating the sum of distances for a current extracted node is performed by a source node comprising an edge device.

11. The method of claim 1, wherein the updating the minsum is performed by a server in a network comprising the server and the plurality of source nodes.

12. The method of claim 1, wherein outputting the centroid node comprises sending the centroid node to all remaining connected source nodes.

13. The method of claim 1, wherein one of the plurality of source nodes disconnects from the network and the centroid node is determined based on the sum of distances associated with the plurality of source nodes that remain connected to the network.

14. The method of claim 1, further comprising exploring nodes near the centroid node using Dijkstra's algorithm to satisfy a criterion.

15. The method of claim 13, wherein the criterion is related to a meeting place.

16. A system for finding the centroid of a plurality of source nodes a network comprising a larger set of nodes comprising:
a memory comprising non-transitory computer-readable storage medium configured to store algorithms, minsum values, and data; and
one or more processors in a distributed computing system configured to execute instructions stored on the non-transitory computer-readable storage medium to:
create a priority queue for each source node of the plurality of source nodes, the priority queue comprising other nodes in the larger set of nodes in the network;
initialize a distance for each of the plurality of source nodes to 0, a distance for the other nodes in the larger set of nodes to ∞, and a minsum to ∞;
select and extract an unvisited node having a smallest value for shortest path distance to a source node;
update a sum of distances for a current extracted node using a shortest path algorithm, the sum of distances comprising a sum total of distances from the current extracted node to all of the plurality of source nodes;
if the current extracted node comprises an intersection node, the intersection node having an updated distance to each of the plurality of source nodes, compare a sum of distances for the intersection node with the minsum;
if the sum of distances is less than the minsum, update the minsum to the sum of distances;
determine whether a stopping condition is met;
if the stopping condition is not met, iteratively update sums of distances using the shortest path algorithm for remaining unvisited nodes from the priority queue, alternating between the priority queues for each of the plurality of source nodes;
after the stopping condition is met for the source node, terminate the shortest path algorithm for the source node;
determine whether the shortest path algorithm has been terminated for all of the plurality of source nodes;
if the shortest path algorithm has been terminated for all of the plurality of source nodes, output a centroid node comprising the intersection node having a sum of distances equal to the minsum wherein the minsum comprises the smallest sum of distances.
